(19) United States
(12) Patent Application Publication
(10) Pub. No.: US 2023/0071821 A1
(43) Pub. Date: Mar. 9, 2023

(54) PRODUCT IDENTIFICATION METHOD AND SALES SYSTEM USING THE SAME

(71) Applicant: INFINIQ Co., Ltd., Seoul (KR)

(72) Inventor: Sungun NOH, Seoul (KR)

(21) Appl. No.: 17/468,108

(22) Filed: Sep. 7, 2021

(51) Int. Cl. G06Q 20/20; G06T 7/194; G06T 7/155; G06K 9/62

(52) U.S. Cl. CPC G06Q 20/208; G06Q 20/201; G06T 7/194; G06T 7/155; G06K 9/6284; G06T 2207/10028; G06T 2207/20081

(57) ABSTRACT

Proposed is a method of identifying a product from an image obtained through a camera. The product identification method includes the steps of: receiving a product image including objects, by a client; acquiring a first object area using depth information included in the input product image; acquiring a second object area through a machine learning network using color information included in the input product image; receiving the acquired first object area and second object region from the client, and verifying whether the object areas match by comparing the object areas, by a server; and reading price information corresponding to an identified object on the basis of a verification result received from the server, and inducing payment for the object, by the client.

### STATEMENT REGARDING PRIOR DISCLOSURES BY THE INVENTORS

The inventor of the present application is the inventor (author) of the Korean Patent No. 10-2190315, published on Dec. 11, 2020, one year or less before the effective filing date of the present application, which is not prior art under 35 U.S.C. 102(b)(1)(A).

### BACKGROUND OF THE INVENTION

### Field of the Invention

The present invention is a technique related to computer vision, and particularly, to a method of identifying a product from an image acquired through a camera on the basis of machine learning, and a sales system using the same.

### Background of the Related Art

Computer vision refers to an application field of computer science that compares computers to human eyes to recognize three-dimensional objects found in the real world, or uses three-dimensional information using various scientific knowledge. The technique of computer vision has also grown together with development of camera and sensor techniques, and various attempts are made in combination with artificial intelligence techniques explosively developed recently.

However, unlike the visual information and recognition system of animals including human being, in the computer vision, loss, transformation or distortion of information occurs in the process of recording a three-dimensional object as pixels in a two-dimensional image. This problem is caused by various factors such as camera lenses, lighting, background congestions and the like, and shows further higher limitations due to the current artificial intelligence techniques that do not perfectly simulate the cognitive ability through human brains.

On the other hand, ideas of recognizing objects using computer vision and operating unmanned stores through the objects are experimentally presented recently. In the prior art document presented below, a system for searching product using object recognition is introduced.
(Patent document 1) Korea Patent Registration No. 10-1852598, “System for searching product using object recognition”

### SUMMARY OF THE INVENTION

Therefore, the present invention has been made in view of the above problems, and it is an object of the present invention to solve the inherent weakness of sensors, which appears as the conventional computer vision techniques depend on fragmentary camera sensor techniques, to overcome the limitation that real-time services are difficult to provide as the conventional techniques concentrate only on advanced artificial intelligence algorithms to recognize objects from an image, and to solve technical weakness that makes sales based on object recognition difficult due to the difference between the products sold by a company having a plurality of branches or stores.

To accomplish the above object, according to one aspect of the present invention, there is provided a product identification method comprising the steps of: (a) receiving a product image including objects, by a client; (b) acquiring a first object area using depth information included in the input product image, by the client; (c) acquiring a second object area through a machine learning network using color information included in the input product image, by the client; (d) receiving the acquired first object area and second object region from the client, and verifying whether the object areas match by comparing the object areas, by a server; and (e) reading price information corresponding to an identified object on the basis of a verification result received from the server, and inducing payment for the object, by the client.

In the product identification method according to an embodiment, step (b) of acquiring a first object area may include the steps of: (b1) acquiring depth information from the product image using at least one among stereo vision, structured pattern, and Time-of-Flight (ToF); (b2) separating a foreground corresponding to an object and a background that is a remaining area from each other using the acquired depth information; and (b3) extracting only an object area by removing the separated background. In addition, step (b) of acquiring a first object area may further include the steps of: (b4) removing noise from the extracted object area using a morphology operation; (b5) comparing a size of the object area from which the noise is removed with a preset threshold value in consideration of a type of the product, and deleting an object area smaller than the threshold value; and (b6) extracting a contour from an object area exceeding the threshold value and setting as the first object area.

In the product identification method according to an embodiment, step (c) of acquiring a second object area may include the steps of: (c1) performing machine learning in advance using learning data of each product type of a plurality of products to generate a machine learning network to which a dataset is applied; (c2) recognizing an object through the machine learning network with reference to the color information included in the product image; and (c3) setting the recognized object as the second object area.

In the product identification method according to an embodiment, step (d) of verifying whether the object areas match may include the steps of: (d1) receiving the acquired first object area and second object area from the client; (d2) verifying whether at least an evaluation metric of each object or the number of identified objects matches by comparing the first object area and the second object area; and (d3) returning a verification result to the client. In addition, step (d2) of verifying whether at least an evaluation metric of each object or the number of identified objects matches may include the step of calculating a ratio of an intersection area to a union area between the areas for each of the objects included in the first object area and the second object area, and classifying the objects as a normally recognized object or an abnormally recognized object using a reference value in which the calculated ratio is set in advance.

In the product identification method according to an embodiment, step (e) of inducing payment may include the steps of: (e1) reading previously stored price information corresponding to the object identified as a normally recognized object from a price database on the basis of the verification result received from the server; and (e2) inducing a consumer who desires to purchase the product to make a payment for the object of which the price information is read.

The product identification method according to an embodiment may further include the step of (f) receiving product information through the client or the server for the object identified as an abnormally recognized object on the basis of the verification result received from the server, and updating the product information as latest product information. In addition, step (f) of updating the product information as latest product information may include the steps of: (f1) receiving product information including a product image and price information for an object identified as an abnormally recognized object; (f2) updating a dataset for machine learning by additionally learning the input product image; and (f3) distributing the updated dataset to at least one or more clients connected to the server.

In the product identification method according to an embodiment, the client may be located in each branch where product sales are made and store a local dataset for object identification and product information including price information to induce payment for the identified object together with a Point-Of-Sale (POS) system, and the server may be connected to a plurality of clients through a network to perform verification on the object recognized through the client, collect the local dataset from the plurality of clients to update a global dataset, and redistribute the global dataset and the product information including the price information to the client.

### BRIEF DESCRIPTION OF THE DRAWINGS

FIG. 1 is a view showing the basic idea of the present invention for identifying a product by using both depth information and color information.

FIG. 2 is a flowchart illustrating a product identification method according to an embodiment of the present invention.

FIG. 3 is a block diagram showing a sales system using a product identification method according to an embodiment of the present invention.

FIG. 4 is a flowchart illustrating an object recognition process using depth information in more detail in a product identification method according to an embodiment of the present invention.

FIGS. 5A to 5E are views showing an experimental example implementing an object recognition process using depth information.

FIG. 6 is a flowchart illustrating an object recognition process using color information and machine learning in more detail in a product identification method according to an embodiment of the present invention.

FIGS. 7A and 7B are views showing an experimental example implementing an object recognition process using color information and machine learning.

FIG. 8 is a flowchart illustrating a process of verifying a recognized object and making a payment in more detail in a product identification method according to an embodiment of the present invention.

FIGS. 9A TO 9C are views showing an evaluation metric that can be utilized in a process of verifying a recognized object.

### DESCRIPTION OF SYMBOLS

10: Client
11: Camera
13: Processing unit of client
15: Local database stored in client
17: First and second object areas
20: Server
23: Processing unit of server
25: Global database stored in server
30: Network

### DETAILED DESCRIPTION OF THE PREFERRED EMBODIMENT

Before describing the embodiments of the present invention, the technical means adopted in the embodiments of the present invention will be schematically introduced, and then specific components will be described sequentially.

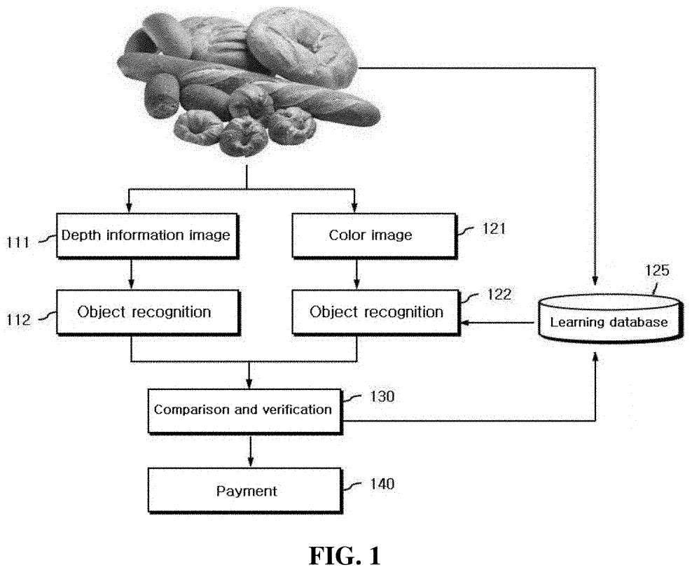

FIG. 1 is a view showing the basic idea of the present invention for identifying a product by using both depth information and color information. It is noted that although bread/bakery products are used as target objects to be identified in the embodiments of the present invention described below, this is only an example selected from the aspect of implementation, and not intended to limit target products.

In the embodiments of the present invention, largely, two types of information are included in an image acquired from a target product. One is depth information, and the other is color information. First, a depth information image (111) may be acquired from a product, and objects (bread) may be recognized therefrom (112). In addition, a color image (121) may be acquired from the product, and an object (bread) may be recognized therefrom (122). At this point, in the case of object recognition using color image, a learning database (125) machine-learned for various objects (bread) in advance is used. That is, an object is recognized using a learning dataset with reference to the color information.

Then, whether each recognized result is correct is verified by comparing the previously recognized two types of objects (130). When it is determined that the object recognition is correctly performed as a result of the verification, a price is matched to a corresponding object, and the consumer is induced to make a payment (140). On the other hand, when the object recognition is incorrect, information on the incorrect object is reflected to the learning database (125). Incorrect object recognition occurs when two types of objects do not match due to inadequate depth information or an inadequate learning database. Particularly, since there may be a slight difference in appearance in the case of a product such as bread although the products are of the same type, additional learning or information input is needed for the incorrect object.

As described above briefly, the embodiments of the present invention are designed to improve identification performance by performing object recognition using two types of information (depth information and color information) having different characteristics and complementing incorrect recognition results.

Hereinafter, the embodiments of the present invention will be described in detail with reference to the accompanying drawings. However, detailed descriptions of well-known functions or configurations that may obscure the gist of the present invention will be omitted from the following description and accompanying drawings. In addition, throughout the specification, ‘including’ a certain component does not exclude other components unless otherwise stated, but means that other components may be further included.

In addition, although terms such as first, second or the like may be used to describe various components, the components should not be limited by the terms. The terms may be used for the purpose of distinguishing one component from the other components. For example, a first component may be referred to as a second component without departing from the scope of the present invention, and similarly, the second component may also be referred to as the first component.

The terms used in the present invention are used only to describe specific embodiments, and are not intended to limit the present invention. Singular expressions include plural expressions unless the context clearly means otherwise. It should be understood that in the present application, terms such as “comprise” or “have” are intended to specify existence of the embodied features, numbers, steps, operations, components, parts, or combinations thereof, and do not exclude in advance the possibility of existence or addition of one or more other features, numbers, steps, operations, components, parts, or combinations thereof.

Unless otherwise specially defined, all terms used herein, including technical or scientific terms, have the same meaning as commonly understood by those skilled in the art. The terms such as those defined in a commonly used dictionary should be interpreted as having a meaning consistent with the meaning in the context of related techniques, and should not be interpreted as an ideal or excessively formal meaning unless clearly defined in this application.

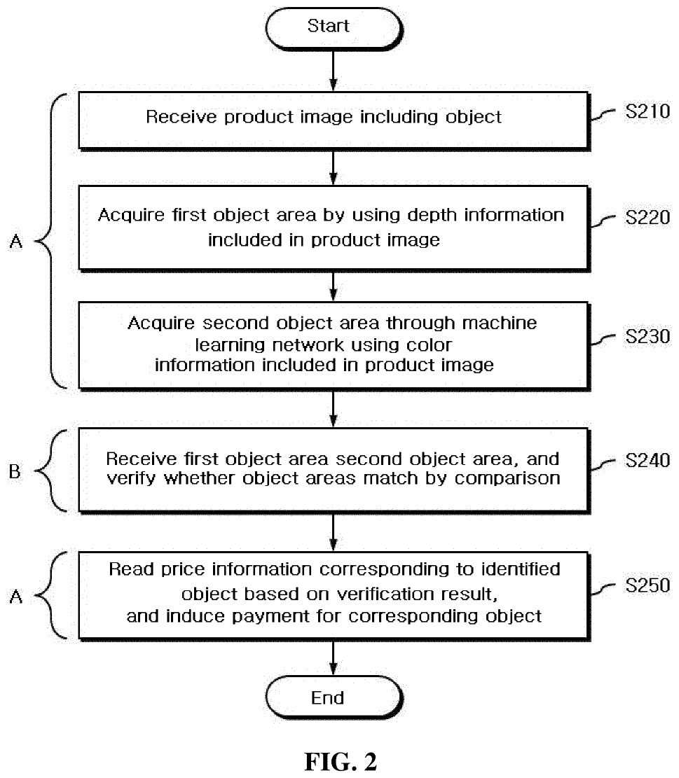

FIG. 2 is a flowchart illustrating a product identification method according to an embodiment of the present invention. The time-series process shown in FIG. 2 is defined by separating the execution subject to maximize product identification performance in consideration of actual implementation environments and performance of existing hardware. For example, execution subject ‘A’ may be implemented as a client provided at a site where products are sold, and execution subject ‘B’ may be implemented as a server connected to a plurality of clients through a network.

At step S210, a client receives a product image including objects. To this end, the client may photograph and receive the product image by further providing a camera or through a separately provided camera together with a point-of-sale (POS) system. In this case, the camera may be implemented as a depth camera, which is a hardware device capable of acquiring depth information of pixels in an image in addition to general color information.

At step S220, the client acquires a first object area using the depth information included in the product image input through step S210. When the client acquires the depth information on the basis of hardware (depth camera) and detects an object using the depth information, it is possible to simply and quickly acquire the object. However, in this case, there is a weakness in that object recognition is greatly affected by the light existing around the object, and particularly, it is pointed out as a weakness that when reflected light is strong, the depth information is distorted and becomes inaccurate. Accordingly, in the embodiments of the present invention, object recognition is performed using color information and machine learning together in addition to the depth information.

At step S230, the client acquires a second object area through a machine learning network using the color information included in the product image input through step S210. Unlike the object recognition based on hardware through step S220, object recognition is performed using software at step S230. To this end, an object may be detected using deep learning or the like on the basis of a dataset learned in advance. Particularly, when learning on various types of bread is completed by utilizing the color information and morphological characteristics unique to the object such as bread presented as an example in the embodiments of the present invention, there is an advantage in that object recognition robust to the effect of light can be made. However, in the case of object recognition through machine learning, there may be a problem in that an object is not detected or is detected repeatedly, and there is a disadvantage in that a new object that has not been learned in advance is difficult to recognize. Accordingly, an object of the embodiments of the present invention is to improve the performance of object recognition by compensating for the weakness of object recognition by utilizing the object areas recognized through steps S220 and S230.

Meanwhile, those skilled in the art may understand that steps S220 and S230 of FIG. 2 do not need to be sequentially performed in the time sequence, and may be implemented in parallel or by changing the order as needed in an implementation.

At step S240, the server receives the acquired first object area and second object area from the client, and verifies whether the object areas match by comparing the object areas. Although various verification means may be used in comparing the object areas respectively acquired according to the two types of recognition methods, recognition performance may be evaluated by arithmetically calculating the degree of matching of the acquired object areas. For example, a method of calculating the overlapping degree of the areas or a method of calculating the matching ratio of the number of areas may be used.

At step S250, the client reads price information corresponding to the identified object on the basis of a verification result received from the server, and induces to make a payment for the object. When all the identified objects match as a result of the verification, the client may fetch price information matched and stored in advance using the identifiers of the objects as a key, calculate a sum of the prices corresponding to the identified objects, and induce the consumer to make a payment. When some of the objects do not match, payment may be induced only for the matching objects, and price information may be manually reflected for the other non-matching objects through the client. In the field where a large number of products are distributed, object recognition may fail according to arrival of new products, and this needs to be compensated for through additional learning. In addition, there may be cases in which the appearance of the same product looks somewhat different among the branches in a situation of operating a plurality of branches, and in this case, the difference among the branches may be resolved by additionally learning the image of the product failed to be recognized as an object.

As described above, considering the load or immediacy of the operation processed at each step, steps S210 to S230 and S250 of FIG. 2 are preferably performed through execution subject ‘A’ (e.g., client) provided in a branch, and step S240 is preferably performed through execution subject ‘B’ (e.g., server) provided in the main office.

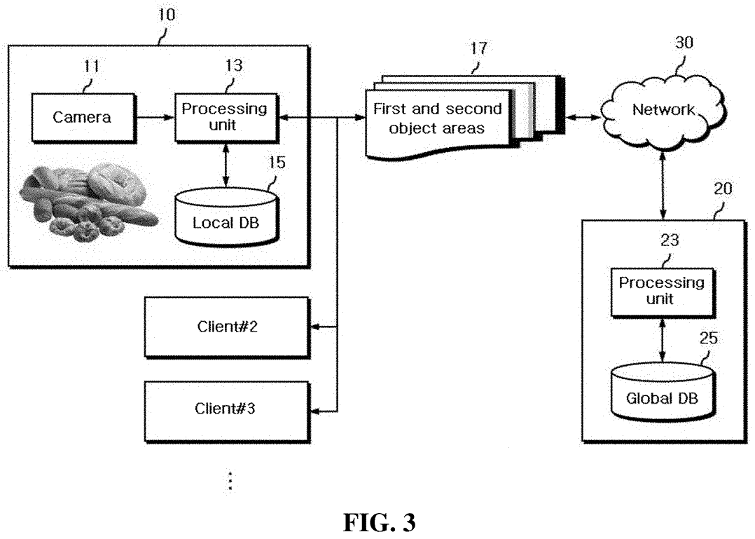

FIG. 3 is a block diagram showing a sales system using a product identification method according to an embodiment of the present invention, in which the process of performing the product identification method of FIG. 2 is reconfigured from the aspect of an execution subject in consideration of hardware configuration and performance.

The client 10 is connected to the server 20 through the network 30, and while the server is implemented as a single device, a plurality of clients may be provided. The client 10 is a configuration that is located in each branch where product sales are made and stores a local dataset 15 for object identification and product information including price information to induce payment for an identified object together with a Point-Of-Sale (POS) system. Particularly, the client 10 is preferably provided with a camera 11 for acquiring information on a product (particularly, it should include depth information) selected by a consumer at a branch. A processing unit 13 extracts a first object area based on the depth information from an image obtained through the camera 11, and extracts a second object area using color information and machine learning. The extracted first and second object areas 17 are transmitted to the server 20 through the network 30. At this point, preferably, initial learning of the local dataset 15 is receiving and storing a result of learning performed through the server 20 or a separate high-performance device.

The processing unit 23 of the server 20 performs verification on the object recognized through the client 10, and it may collect the local dataset 15 from a plurality of clients to update a global dataset 25 and redistribute the global dataset 25 and the product information including the price information to the client 10. From the aspect of load, the server 20 preferably includes a graphics processing unit (GPU), and may perform data learning and object comparison in real-time on the basis of high-performance hardware.

As described above, it is possible to compensate for the weakness of object recognition and improve object recognition performance using two types of image recognition techniques together. Since at least two cameras or sensors are used for depth information, all the objects in a photographed image may be detected. However, there is a weakness in that depth information cannot be normally expressed when light is directly reflected to the camera. On the contrary, although machine learning such as deep learning is capable of detecting and recognizing various objects in a photographed image at least for a previously learned object, a weakness is found in detecting a new object that is not learned, and occasionally, there is a problem of finding duplicated objects in the detection and recognition process, which is different from the actual number of objects. In the embodiments of the present invention, the speed and accuracy of object recognition may be improved by complementing the two types of image recognition methods and sharing the roles between the client and the server.

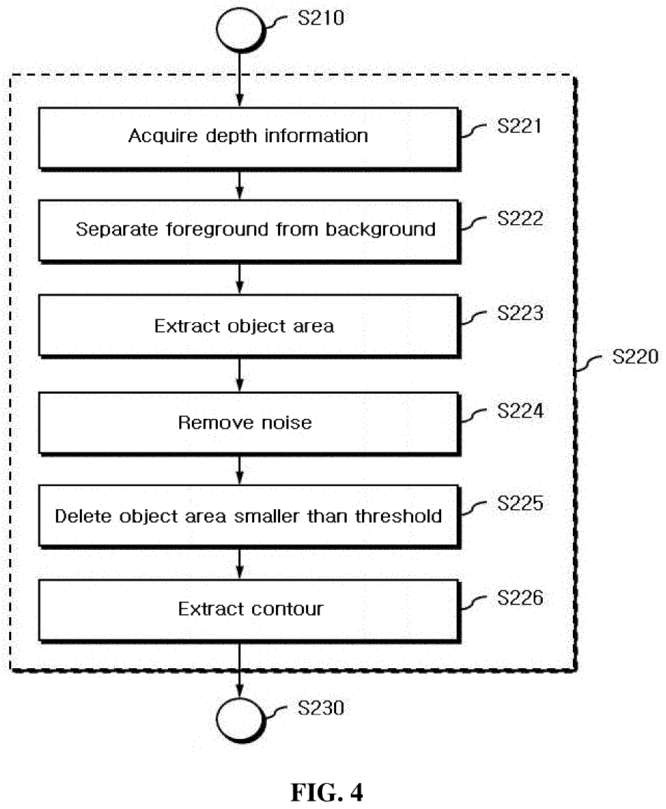

FIG. 4 is a flowchart illustrating an object recognition process (S220 of FIG. 2) using depth information in more detail in a product identification method according to an embodiment of the present invention.

At step S221, depth information is acquired from a product image. At least one among the stereo vision, structured pattern, and Time-of-Flight (ToF) may be used to acquire the depth information. The stereo vision acquires a depth resolution of a subject using the viewpoint mismatch of at least two image sensors (e.g., a left camera and a right camera). Alternatively, the depth information may be acquired from distortion of a pattern projected by casting a structured pattern on a subject and photographing a result image using an image sensor. Furthermore, movement time information may be acquired by measuring a delay or phase shift of a modulated optical signal for all pixels of a scene, and the depth information may be obtained using a correlation function.

At step S222, a foreground corresponding to the object and a background that is the remaining area are separated from each other using the depth information acquired through step S221. Technically, an area nearer than a reference depth (near field) and an area farther than the reference depth (far field) may be separated on the basis of the depth information.

At step S223, only object areas are extracted by removing the separated background through step S222. From the aspect of implementation, for example, only an object from which the background is removed may be extracted by roughly specifying an area including the foreground in an image as a rectangle using the OpenCV's GrabCut algorithm and marking whether a background part is included in the foreground area or whether there exists an omitted foreground part.

At step S224, noise is removed from the object area extracted through step S223 by using a morphology operation. An erosion operation or a dilation operation may be used as needed in an implementation, and fine noise other than actual objects may be removed using the geometric form of the image in the object area, for example, through an erosion operation on the object.

At step S225, the size of the object area from which the noise is removed is compared with a preset threshold value in consideration of the type of the product, and an object area smaller than the threshold value is deleted. In the case of the repeatedly exemplified ‘bread’, since the size of an object should be greater than or equal to a certain level, an excessively small area in the morphology operation result may not be determined as bread, which is a recognition target. Therefore, all object areas having a size smaller than or equal to the threshold value are noise, and it is preferable to remove the object areas. At this point, the threshold value may be empirically determined according to the application or environment in which the present invention is used.

At step S226, a contour is extracted from an object area exceeding the threshold value and set as a first object area. Now, the contour is extracted for an object area having a size greater than the threshold value by performing a search in each pixel direction through a technique such as edge tracing or boundary flowing, and a rectangular label (bounding box) is assigned to the object.

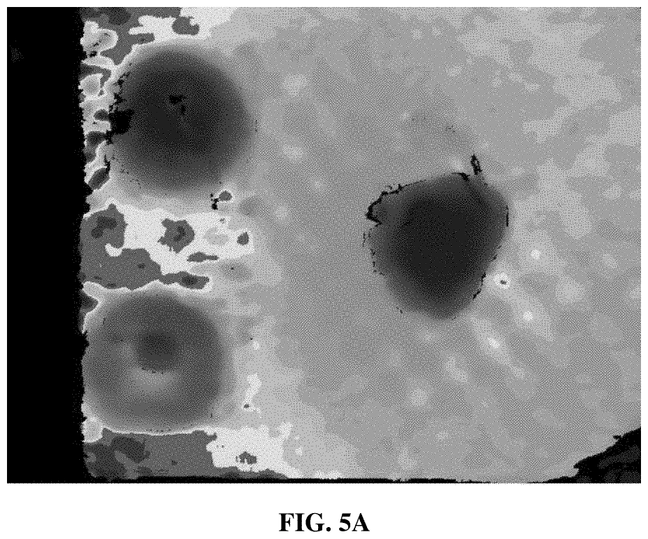

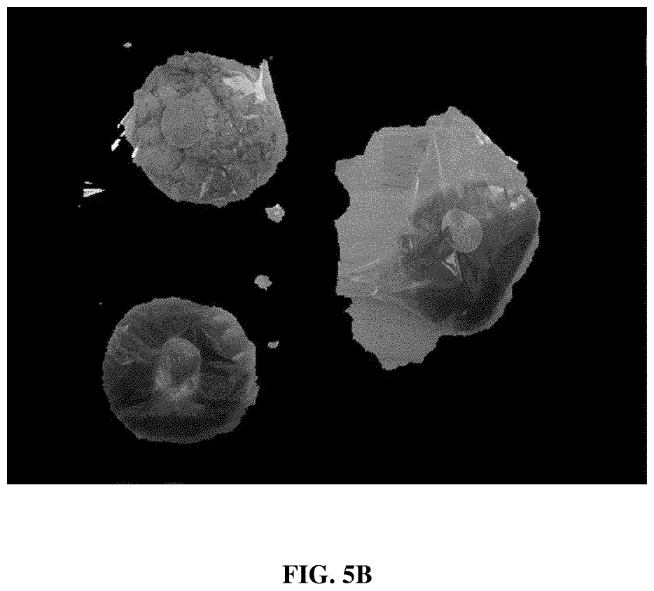

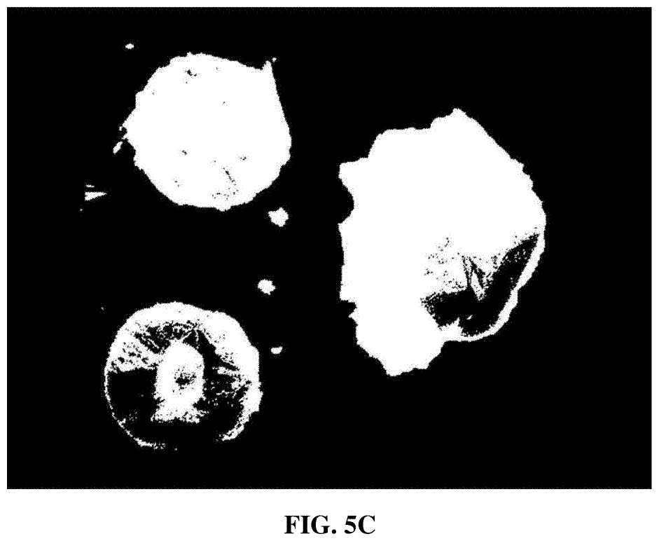

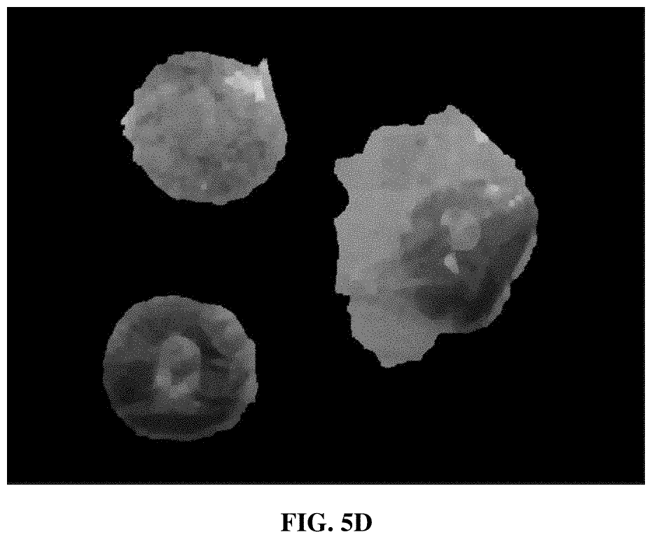

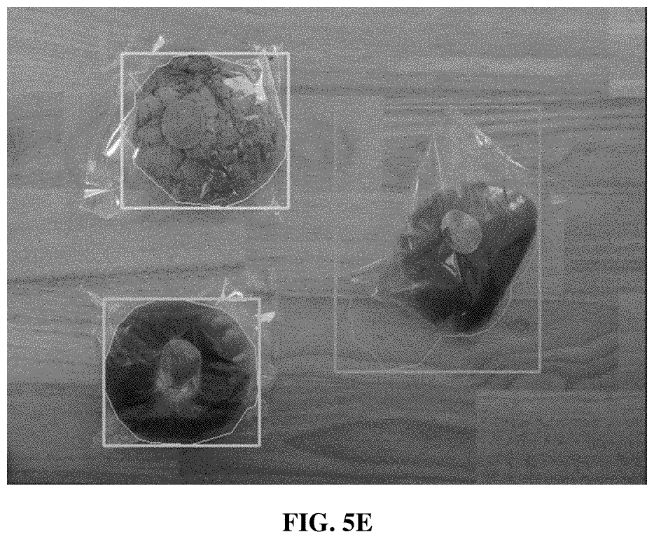

FIGS. 5a to 5e are views showing an experimental example implementing an object recognition process using depth information. FIG. 5A is a view visualized by giving color gradation according to depth, and it may be confirmed that products (bread) displayed in blue color exist in a short-range view rather than a distant view. FIG. 5B shows object areas roughly separated on the basis of depth information, and it is shown that the outlines and rectangle labels of the recognized objects are set as shown in FIG. 5E through the image processing of FIGS. 5C and 5D. FIGS. 5A to 5E are affected by reflection of light since depth information is used, and particularly, it may be confirmed that there is a slight error in the object recognition area due to the bread packaging materials. Such an error is compensated through object recognition using color information and machine learning.

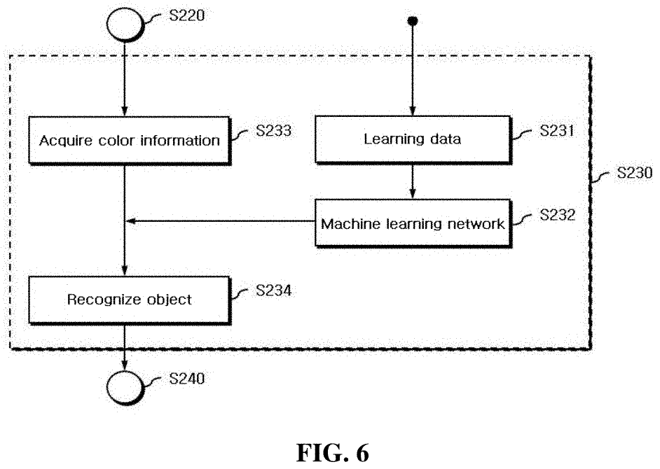

FIG. 6 is a flowchart illustrating an object recognition process using color information and machine learning (S230 of FIG. 2) in more detail in a product identification method according to an embodiment of the present invention.

At step S231, machine learning is performed in advance using learning data of each product type of a plurality of products to generate a machine learning network to which the dataset of step S232 is applied. Since the machine learning generates much load as described above, this process is preferably performed through a server or separate high-performance equipment. Once the learning is completed, a learning result is transmitted to the client to be used for object recognition through each client. That is, it is preferable to perform unified learning through the server and reflect the learning result to individual clients. From the aspect of implementation, once a color image (*.jpg file) and an attribute assignment file (*.json file) for learning are prepared, learning is performed using an algorithm selected for learning (e.g., deep learning algorithm), and a dataset is output. It is preferable to generate or process the dataset output in this way in a form (*.cvs file) advantageous for distribution.

At step S233, color information included in the product image is acquired, and at step S234, an object is recognized through the machine learning network with reference to the color information. When a situation of including a plurality of objects in an image is considered, the objects may be recognized by using, for example, a segmentation model, and as an identifier specifying an object type is matched to the recognized objects, it becomes a basis for determining price in the future. Since various methods of performing machine learning or methods of applying a learning model may be appropriately selected by those skilled in the art and there is a risk of harming the essence of the present invention, a detailed description thereof will be omitted. Now, the object recognized based on the color information is set and output as a second object area.

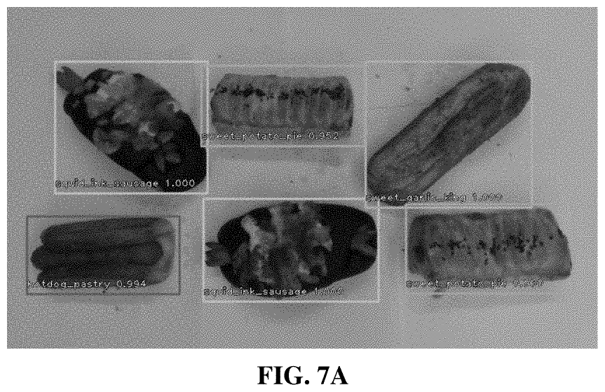

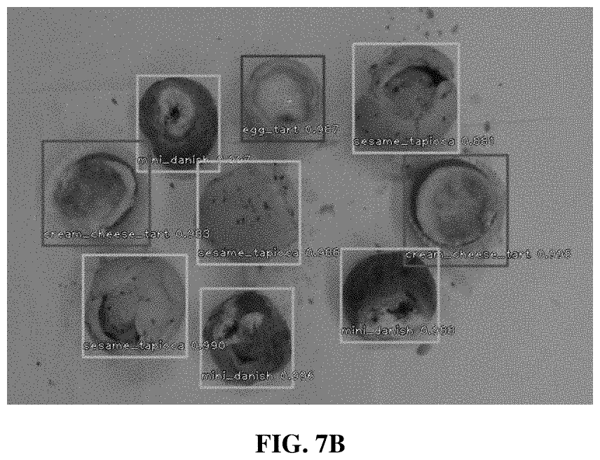

FIGS. 7A and 7B are views showing an experimental example implementing an object recognition process using color information and machine learning. Referring to FIGS. 7A and 7B, various types of bread are recognized, and it may be confirmed that the name of bread is attached to each object as a label. Particularly, since the object type itself is important information that cannot be obtained in the object recognition process through depth information, it is used thereafter as a key for determining the price of the object.

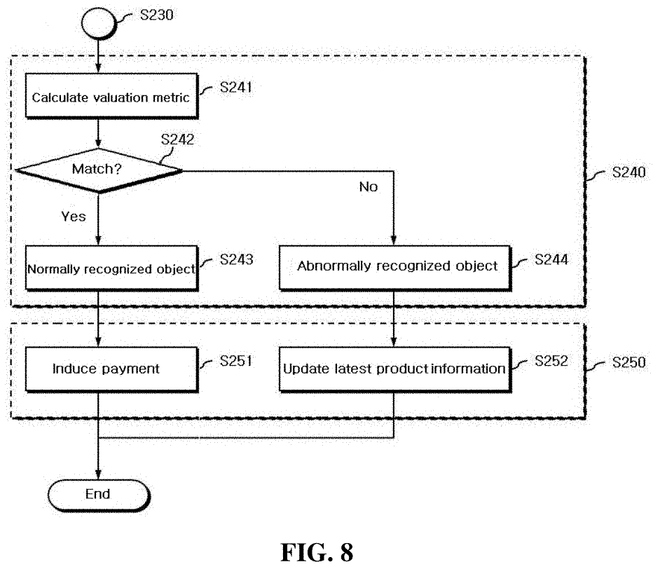

FIG. 8 is a flowchart illustrating a process of verifying a recognized object and making a payment (S240 and S250 of FIG. 2) in more detail in a product identification method according to an embodiment of the present invention. At this point, it is preferable that the verification process S240 is performed through the server, and the payment process S250 is performed through the client. First, the server receives a first object area (based on depth information) and a second object area (based on color information) from the client.

At step S241, the first object area and the second object area are compared to calculate an evaluation metric of each object or the number of identified objects, and whether the object areas matches is verified through step S242. At this point, the evaluation metric of each object may be inspected on the premise that the number of identified objects completely matches, or verification may be performed by utilizing only any one of the inspection items. Here, the evaluation metric is a value obtained by digitizing a degree of match between the two object areas, and may be calculated by comprehensively considering the correspondence relationship of the area occupied by each object area and the coordinates of the object.

When the object areas match as a result of the verification at step S242, the process proceeds to step S243 to classify the object as a normally recognized object, whereas when the object areas do not match, the object is classified as an abnormally recognized object at step S244. At this point, determining whether or not the object areas match does not mean arithmetically perfect matching, but the matching is determined in comparison with a predetermined standard. For example, when a degree of matching of 85% or more is calculated arithmetically, the object areas may be determined as being matched.

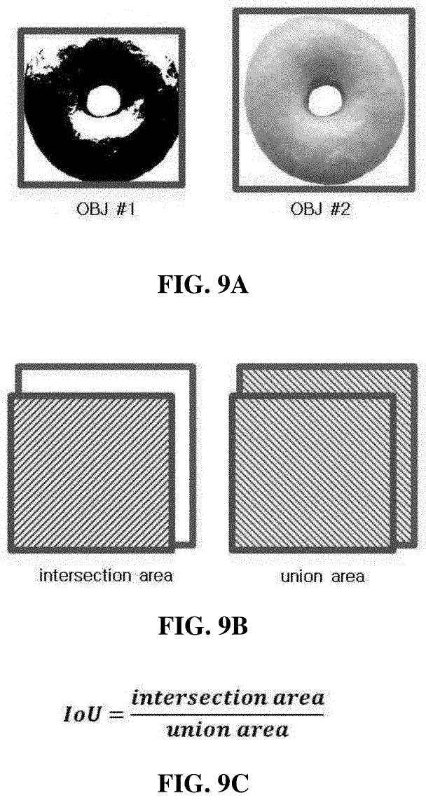

FIGS. 9A to 9C is a view showing an evaluation metric that can be utilized in a process of verifying a recognized object, and it shows the process of determining whether or not the object matches through Intersection over Union (IoU).

FIG. 9A shows objects (OBJ #1, OBJ #2) recognized according to different methods for the same product (bread), and object areas are set in red and blue, respectively. FIG. 9B shows an intersection area expressed using red oblique lines and a union area expressed using blue oblique lines by comparing object areas according to two types that are set. Now, an evaluation metric defined as shown in Equation 1 is calculated through FIG. 9C.

$$IoU = \frac{i n t e r s e ction area}{union area} \qquad [ Equation 1 ]$$

That is, a ratio of the intersection area to the union area may be calculated through Equation 1, and the object may be classified as a normally recognized object or an abnormally recognized object using a reference value in which the calculated ratio is set in advance.

Returning to FIG. 8 again, at step S250, a verification result is returned to the client. When the object is classified as a normally recognized object through step S243, the client induces the consumer to make a payment at step S251. On the other hand, in succession to step S251, the client may read previously stored price information corresponding to the object identified as a normally recognized object from a price database on the basis of the verification result received from the server, and induce a consumer who desires to purchase the product to make a payment for the object of which the price information is read.

On the other hand, when the object is classified as an abnormally recognized object at step S244, product information may be received through the client or the server for the object identified as an abnormally recognized object on the basis of the verification result received from the server, and updated as latest product information at step S252. To this end, product information including a product image and price information is received for the object identified as an abnormally recognized object, and the dataset for machine learning may be updated by additionally learning the input product image. The update process of the dataset is preferably performed through the server. Then, the updated dataset is distributed to at least one or more clients connected to the server so that the clients may maintain the latest product information.

As the embodiments of the present invention described above use both object recognition based on depth information and object recognition based on color information and verify the results of the two types of object recognition through the server, it is possible to minimize the error generated due to the effect of light, accurately segment and recognize objects, and guarantee a high recognition rate although products are identified in real-time. Furthermore, the difference of learning data among a plurality of clients may be reduced by redistributing the learning data of the centralized server.

On the other hand, the embodiments of the present invention may be implemented as computer-readable codes in a computer-readable recording medium. The computer-readable recording medium includes all types of recording devices for storing data that can be read by a computer system.

Examples of the computer-readable recording medium include ROM, RAM, CD-ROM, magnetic tape, floppy disk, optical data storage device and the like. In addition, the computer-readable recording medium may be distributed in computer systems connected through a network to store and execute computer-readable codes in a distributed manner. In addition, functional programs, codes, and code segments for implementing the present invention may be easily inferred by programmers in the art.

The present invention has been described above mainly focusing on various embodiments. Those skilled in the art may understand that the present invention may be implemented in a modified form without departing from the essential characteristics of the present invention. Therefore, the disclosed embodiments should be considered in an illustrative viewpoint rather than a restrictive viewpoint. The scope of the present invention is shown in the claims rather than the above description, and all differences within the scope equivalent thereto should be construed as being included in the present invention.

As the embodiments of the present invention described above use both object recognition based on depth information and object recognition based on color information and verify the results of the two types of object recognition through the server, it is possible to minimize the error generated due to the effect of light, accurately segment and recognize objects, and guarantee a high recognition rate although products are identified in real-time. Furthermore, the difference of learning data among a plurality of clients may be reduced by redistributing the learning data of the centralized server.

What is claimed is:

1. A product identification method comprising the steps of:
(a) receiving a product image including objects by acquiring depth information of pixels in an image using a depth camera in addition to color information, by a client;
(b) acquiring a first object area using the depth information included in the input product image, by the client;
(c) acquiring a second object area through a machine learning network that has learned a plurality of objects using the color information included in the input product image, by the client;
(d) receiving the acquired first object area based on the depth information and second object region based on color information from the client, and verifying whether the object areas match by comparing the object areas, by a server; and
(e) reading price information corresponding to an identified object on the basis of a verification result received from the server, and inducing payment for the object, by the client.

2. The method according to claim 1, wherein step (b) includes the steps of:
(b1) acquiring depth information from the product image using at least one among stereo vision, structured pattern, and Time-of-Flight (ToF);
(b2) separating a foreground corresponding to an object and a background that is a remaining area from each other using the acquired depth information; and
(b3) extracting only an object area by removing the separated background.

3. The method according to claim 2, wherein step (b) further includes the steps of:
(b4) removing noise from the extracted object area using a morphology operation;
(b5) comparing a size of the object area from which the noise is removed with a preset threshold value in consideration of a type of the product, and deleting an object area smaller than the threshold value; and
(b6) extracting a contour from an object area exceeding the threshold value and setting as the first object area.

4. The method according to claim 1, wherein step (c) includes the steps of:
(c1) performing machine learning in advance using learning data of each product type of a plurality of products to generate a machine learning network to which a dataset is applied;
(c2) recognizing an object through the machine learning network with reference to the color information included in the product image; and
(c3) setting the recognized object as the second object area.

5. The method according to claim 1, wherein step (d) includes the steps of:
(d1) receiving the acquired first object area and second object area from the client;
(d2) verifying whether at least an evaluation metric of each object or the number of identified objects matches by comparing the first object area and the second object area; and
(d3) returning a verification result to the client.

6. The method according to claim 5, wherein step (d2) includes the step of calculating a ratio of an intersection area to a union area between the areas for each of the objects included in the first object area and the second object area, and classifying the objects as a normally recognized object or an abnormally recognized object using a reference value in which the calculated ratio is set in advance.

7. The method according to claim 1, wherein step (e) includes the steps of:
(e1) reading previously stored price information corresponding to the object identified as a normally recognized object from a price database on the basis of the verification result received from the server; and
(e2) inducing a consumer who desires to purchase the product to make a payment for the object of which the price information is read.

8. The method according to claim 1, further comprising the step of (f) receiving product information through the client or the server for the object identified as an abnormally recognized object on the basis of the verification result received from the server, and updating the product information as latest product information.

9. The method according to claim 8, wherein step (f) includes the steps of:
(f1) receiving product information including a product image and price information for an object identified as an abnormally recognized object;
(f2) updating a dataset for machine learning by additionally learning the input product image; and
(f3) distributing the updated dataset to at least one or more clients connected to the server.

10. The method according to claim 1, wherein the client is located in each branch where product sales are made and stores a local dataset for object identification and product information including price information to induce payment for the identified object together with a Point-Of-Sale (POS) system, and the server is connected to a plurality of clients through a network to perform verification on the object recognized through the client, collect the local dataset from the plurality of clients to update a global dataset, and redistribute the global dataset and the product information including the price information to the client.
